(19) United States
(12) Patent Application Publication
(10) Pub. No.: US 2019/0256727 A1
(43) Pub. Date: Aug. 22, 2019

(54) IMAGE FORMING METHOD, METHOD OF MANUFACTURING PRINTED MATTER, AND SET OF PRE-PROCESSING FLUID AND INK

(71) Applicants: Mio KUMAI, Tokyo (JP); Akiyoshi SABU, Kanagawa (JP); Atsushi YAMAMOTO, Tokyo (JP); Azumi MIYAAKE, Kanagawa (JP); Hidefumi NAGASHIMA, Kanagawa (JP); Yuri HAGA, Tokyo (JP)

(72) Inventors: Mio KUMAI, Tokyo (JP); Akiyoshi SABU, Kanagawa (JP); Atsushi YAMAMOTO, Tokyo (JP); Azumi MIYAAKE, Kanagawa (JP); Hidefumi NAGASHIMA, Kanagawa (JP); Yuri HAGA, Tokyo (JP)

(21) Appl. No.: 16/269,630

(22) Filed: Feb. 7, 2019

(30) Foreign Application Priority Data
Feb. 20, 2018 (JP) 2018-027955

(51) Int. Cl. C09D 11/54; B41M 5/00; C09D 11/322; C09D 11/037; C09D 11/033

(52) U.S. Cl. CPC C09D 11/54; B41M 5/0023; C09D 11/033; C09D 11/037; C09D 11/322

(57) ABSTRACT

An image forming method includes applying a pre-processing fluid to a recording medium and applying an ink to the recording medium to form an image thereon, wherein the ink comprises a magenta ink comprising water, an azo pigment, a quinacridone pigment, and an organic solvent.

### CROSS-REFERENCE TO RELATED APPLICATIONS

This patent application is based on and claims priority pursuant to 35 U.S.C. § 119 to Japanese Patent Application No 2018-027955, filed on Feb. 20, 2018, in the Japan Patent Office, the entire disclosure of which is hereby incorporated by reference herein.

### BACKGROUND

### Technical Field

The present invention relates to an image forming method, a method of manufacturing printed matter, and a set of pre-processing fluid and ink.

### Description of the Related Art

In inkjet recording methods, ink droplets are directly discharged from extremely fine nozzles to a recording medium to attach the ink droplets thereto to form texts and images. Devices employing these inkjet methods have advantages of less noises and good operability. Also, colorization is easy and plain paper can be used as the recording medium. For this reason, such devices are widely used at home and offices as the output device. For industrial use, due to advancement of the inkjet technology, those devices are expected as output devices for digital printing. In fact, printers capable of recording on non-absorptive materials with solvent ink and UV ink have been launched. However, in terms of the environment and safety issues, aqueous ink has been demanded.

Pigments for aqueous inkjet ink for use in the industrial fields are required to be finely dispersed. This is because aggregated matter present in the ink causes nozzle clogging, which requires cleaning every time, thereby lowering productivity. Moreover, with a growing anticipation for the inkjet technologies as a substitution for offset printing, quality demanded for inkjet images is high. In particular, image density and light resistance are commonly demanded irrespective of how printed matter is used.

### SUMMARY

According to the present invention, provided is an improved image forming method which includes applying a pre-processing fluid to a recording medium and applying an ink to the recording medium to form an image thereon, wherein the ink comprises a magenta ink comprising water, an azo pigment, a quinacridone pigment, and an organic solvent.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating a perspective view of an example of an inkjet recording device; and

FIG. 2 is a diagram illustrating a perspective view of an example of a main tank of an inkjet recording device.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Moreover, image forming, recording, printing, modeling, etc. in the present disclosure represent the same meaning, unless otherwise specified.

Embodiments of the present invention are described in detail below with reference to accompanying drawing(s). In describing embodiments illustrated in the drawing(s), specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

A combinational use of an azo pigment and a quinacridone pigment has been proposed to strike a balance between dispersibility and light resistance.

Also, an inkjet jet printing method has been proposed in which a particular portion of a cloth fabric product is subjected to pre-processing.

However, image density greatly changes depending on the type of recording media. The combinational use mentioned above is evaluated for only a non-permeating recording medium, which tends to have a high image density. Therefore, it is not possible to conclude that sufficient image density is obtained.

In the inkjet method mentioned above, the subject on which an image is formed is limited to a cloth fabric product. Therefore, the inkjet method fails to strike a balance between dispersibility, light resistance, and image density of a pigment at a high level.

To enhance image density and light resistance, the pigment is required to agglomerate in some degree. However, this is clearly contrary to the fine dispersion state required to prevent nozzle clogging. That is, there is a trade-off between these and an image forming method capable of striking a balance between all at a high level has never been proposed so far.

According to the present disclosure, it is possible to provide an image forming method capable of striking a balance between pigment dispersibility, light resistance, and image density at a high level.

The image forming method, the image forming device, and the method of manufacturing printed matter, and the set of pre-processing fluid and ink relating to the present disclosure are described below. It is to be noted that the following embodiments are not limiting the present disclosure and any deletion, addition, modification, change, etc. can be made within a scope in which man in the art can conceive including other embodiments, and any of which is included within the scope of the present disclosure as long as the effect and feature of the present disclosure are demonstrated.

The image forming method and the method of manufacturing printed matter include applying a pre-processing fluid to a recording medium and thereafter applying an ink to the recording medium on which the pre-processing fluid has been applied to form an image thereon, wherein the ink comprises a magenta ink comprising water, an azo pigment, a quinacridone pigment, and an organic solvent.

The image forming device relating to the present disclosure includes a pre-processing fluid applying device to apply a pre-processing fluid to a recording medium and an ink applying device to apply an ink to the recording medium on which the pre-processing fluid has been applied to form an image thereon, wherein the ink comprises a magenta ink comprising water, an azo pigment, a quinacridone pigment, and an organic solvent.

Since the method and the device of the present disclosure respectively include applying a pre-processing fluid to a recording method and a pre-processing fluid applying device to a recording medium, pigments can stay on the surface of the recording medium, thereby obtaining high image density. This method and device have a significant impact in particular on usage of pigments such as azo pigments having a small crystal diameter or finely-dispersed pigments since those pigments are not easily caught in fiber or a coating agent present on the surface of a recording medium but permeate the area deep inside the recording medium. It is more preferable that the pre-processing fluid comprise any one of a cationic polymer, an aliphatic organic acid salt compound, and an inorganic metal compound because it accelerates pigment aggregation.

Ink

The organic solvent, water, coloring material, resins, and additives for use in the ink are described below.

Organic Solvent

There is no specific limitation to the organic solvent for use in the present disclosure. For example, water-soluble organic solvents can be used. Examples include, but are not limited to, polyols, ethers such as polyol alkylethers and polyol arylethers, nitrogen-containing heterocyclic compounds, amides, amines, and sulfur-containing compounds.

The water-soluble organic solvent has no particular limit.

Specific examples include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether; polyol arylethers such as ethylene glycol monophenylether and ethylene glycol monobenzylether; nitrogen-containing heterocyclic compounds such as 2-pyrolidone, N-methyl-2-pyrolidone, N-hydroxyethyl-2-pyrolidone, 1,3-dimethyl-2-imidazolidinone, ε-caprolactam, and γ-butyrolactone; amides such as formamide, N-methylformamide, N,N-dimetshylformamide, 3-methoxy-N,N-dimethyl propionamide, and 3-butoxy-N,N-dimethyl propionamide; amines such as monoethanolamine, diethanolamine, and triethylamine; sulfur-containing compounds such as dimethyl sulfoxide, sulfolane, and thiodiethanol; propylene carbonate, and ethylene carbonate.

To serve as a humectant and impart a good drying property, it is preferable to use an organic solvent having a boiling point of 250 degrees C. or lower.

Polyol compounds having eight or more carbon atoms and glycol ether compounds are also suitable. Specific examples of the polyol compounds having eight or more carbon atoms include, but are not limited to, 2-ethyl-1,3-hexanediol and 2,2,4-trimethyl-1,3-pentanediol.

Specific examples of the glycolether compounds include, but are not limited to, polyol alkylethers such as ethyleneglycol monoethylether, ethyleneglycol monobutylether, di ethyl eneglycol monomethyl ether, di ethyl eneglycol monoethylether, di ethyl eneglycol monobutylether, tetraethyleneglycol monomethylether, and propyleneglycol monoethylether; and polyol arylethers such as ethyleneglycol monophenylether and ethyleneglycol monobenzylether.

The polyol compounds having eight or more carbon atoms and glycolether compounds enhance permeability of ink for paper used as a recording medium.

The proportion of the organic solvent in the ink has no particular limit and can be suitably selected to suit to a particular application.

In terms of drying property and discharging reliability of ink, the proportion is preferably from 10 to 60 percent by mass and more preferably from 20 to 60 percent by mass.

Water

The proportion of water in the ink is not particularly limited and can be suitably selected to suit to a particular application. For example, in terms of the drying property and discharging reliability of the ink, the proportion is preferably from 10 to 90 percent by mass and more preferably from 20 to 60 percent by mass.

In the present disclosure, known each color ink can be used.

Coloring Material

The coloring material has no particular limit. For example, pigments and dyes are suitable.

As the pigment, inorganic pigments or organic pigments can be used. These can be used alone or in combination. In addition, it is possible to use a mixed crystal.

As the pigments, for example, black pigments, yellow pigments, magenta pigments, cyan pigments, white pigments, green pigments, orange pigments, and gloss pigments and metallic pigments of gold, silver, etc., can be used.

As the inorganic pigments, in addition to titanium oxide, iron oxide, calcium carbonate, barium sulfate, aluminum hydroxide, barium yellow, cadmium red, and chrome yellow, carbon black manufactured by known methods such as contact methods, furnace methods, and thermal methods can be used.

As the organic pigments, it is possible to use azo pigments, polycyclic pigments (phthalocyanine pigments, perylene pigments, perinone pigments, anthraquinone pigments, quinacridone pigments, dioxazine pigments, indigo pigments, thioindigo pigments, isoindolinone pigments, and quinophthalone pigments, etc.), dye chelates (basic dye type chelates, acid dye type chelates, etc.), nitro pigments, nitroso pigments, and aniline black can be used. Of those pigments, pigments having good affinity with solvents are preferable. Also, hollow resin particles and hollow inorganic particles can be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red (PR) 1, 2, 3, 5, 17, 22, 23, 31, 38, 48:2, 48:2 {PermanentRed 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 150, 166, 168, 170, 172, 177, 178, 179, 184, 185, 190, 193, 202, 207, 208, 209, 213, 219, 224, 254, 264, and 269; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63; C.I. Pigment Green 1, 4, 7, 8, 10, 17, 18, and 36.

The dye is not particularly limited and includes, for example, acidic dyes, direct dyes, reactive dyes, basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

In the present disclosure, magenta ink is required to contain an azo pigment and a quinacridone pigment.

Inclusion of an azo pigment in the magenta ink preferably enhances dispersibility of the pigment in the ink. Of the azo pigments, pigments selected from at least one of C.I.PR150, C.I.PR269, and C.I.PR48:3 are preferable in terms of this dispersibility and mutual action with the quinacridone pigment. C.I.PR150 is more preferable.

Inclusion of the quinacridone pigment in the magenta ink preferably enhances light resistance of an image. In addition, the quinacridon pigment has a large crystal diameter and tends to agglomerate. Therefore, the pigment can stay on the surface of a recording medium during printing, which preferably contributes to an increase of image density. In terms of this action effect, of the quinacridone pigments, pigments selected from at least one of C.I.PR122, C.I.PR202, and C.I.PV19 are preferable. C.I.PR122 and/or C.I.PV19 are more preferable.

Inclusion of the azo pigment and the quinacridone pigment in the magenta ink preferably strikes a balance between pigment dispersibility, light resistance, and image density at high levels. Inclusion of only the azo pigment enhances dispersibility but is not preferable in terms of light resistance and image density. Inclusion of only the quinacridone pigment enhances light resistance and image density but is not preferable in terms of dispersibility.

In the magenta ink, the mass ratio (azo pigment to the quinacridone pigment) of the azo pigment and the quinacridone pigment is, for example, from 10:90 to 50:50, preferably from 15:85 to 40:60, and more preferably from 25:75 to 35:65.

In addition, the azo pigment and the quinacridone pigment preferably account for 50 percent by mass and preferably 80 percent by mass of all the pigments for use in the magenta ink.

The proportion of the coloring material in the ink is preferably from 0.1 to 15 percent by mass and more preferably from 1 to 10 percent by mass in terms of enhancement of image density, fixability, and discharging stability.

Dispersion Method of Pigment

To obtain an ink by dispersing a pigment, for example, a hydrophilic functional group is introduced into a pigment to prepare a self-dispersible pigment, the surface of a pigment is coated with a resin followed by dispersion, or a dispersant is used to disperse a pigment.

To prepare a self-dispersible pigment by introducing a hydrophilic functional group into a pigment, for example, it is possible to add a functional group such as sulfone group and carboxyl group to the pigment to disperse the pigment in water.

To coat the surface of a pigment with a resin, the pigment is encapsulated by microcapsules to make the pigment dispersible in water. This can be referred to as a resin-coated pigment. In this case, all the pigments to be added to ink are not necessarily entirely coated with a resin. Pigments partially or wholly uncovered with a resin are allowed to be dispersed in the ink unless such pigments have an adverse impact.

In a method of using a dispersant to disperse a pigment, for example, a known dispersant having a small molecular weight or a large molecular weight, which is represented by a surfactant, is used to disperse the pigment in ink.

As the dispersant, it is possible to use, for example, an anionic surfactant, a cationic surfactant, a nonionic surfactant, an amphoteric surfactant, etc. depending on a pigment. Also, a nonionic surfactant (RT-100, manufactured by TAKEMOTO OIL & FAT CO., LTD.) and a formalin condensate of naphthalene sodium sulfonate are suitable as the dispersant. Those can be used alone or in combination.

Pigment Dispersion

The ink can be obtained by mixing a pigment with materials such as water and an organic solvent. It is also possible to mix the pigment with water, a dispersant, etc., to prepare a pigment dispersion and thereafter mix the pigment dispersion with material such as water and an organic solvent to manufacture the ink.

The pigment dispersion is obtained by mixing and dispersing water, a pigment, a pigment dispersant, and other optional components and controlling the particle size. It is good to use a dispersing device for dispersion.

The particle diameter of the pigment in the pigment dispersion has no particular limit. For example, the maximum frequency is preferably from 20 to 500 nm and more preferably from 20 to 150 nm in the maximum number conversion to improve dispersion stability of the pigment and ameliorate discharging stability and the image quality such as image density. The particle diameter of a pigment can be measured using a particle size analyzer (Nanotrac Wave-UT151, manufactured by MicrotracBEL Corp).

In addition, the proportion of the pigment in the pigment dispersion is not particularly limited and can be suitably selected to suit a particular application. In terms of improving discharging stability and image density, the proportion is preferably from 0.1 to 50 percent by mass and more preferably from 0.1 to 30 percent by mass.

It is preferable that the pigment dispersion be filtered with a filter, a centrifuge, etc. to remove coarse particles followed by degassing.

Resin

The type of the resin contained in the ink has no particular limit and can be suitably selected to suit to a particular application. Examples are urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins.

Resin particles made of such resins can be also used. It is possible to mix a resin emulsion in which such resin particles are dispersed in water as a dispersion medium with materials such as a coloring material and an organic solvent to obtain an ink. It is possible to use suitably-synthesized resin particles. Alternatively, the resin particle is available on the market. These resin particles can be used alone or in combination.

The volume average particle diameter of the resin particle is not particularly limited and can be suitably selected to suit to a particular application. The volume average particle diameter is preferably from 10 to 1,000 nm, more preferably from 10 to 200 nm, and furthermore preferably from 10 to 100 nm to obtain good fixability and image robustness.

The volume average particle diameter can be measured by using, for example, a particle size analyzer (Nanotrac Wave-UT 151, manufactured by MicrotracBEL Corp.).

The proportion of the resin is not particularly limited and can be suitably selected to suit to a particular application. In terms of fixability and storage stability of ink, it is preferably from 1 to 30 percent by mass and more preferably from 5 to 20 percent by mass to the total amount of the ink.

The particle diameter of the solid portion in the ink has no particular limit and can be suitably selected to suit to a particular application. For example, the maximum frequency in the maximum number conversion is preferably from 20 to 1,000 nm and more preferably from 20 to 150 nm to ameliorate the discharging stability and image quality such as image density. The solid portion includes resin particles, particles of pigments, etc. The particle diameter can be measured by using a particle size analyzer (Nanotrac Wave-UT151, manufactured by MicrotracBEL Corp).

Additive

Ink may further optionally include a surfactant, a defoaming agent, a preservative and fungicide, a corrosion inhibitor, a pH regulator, etc.

Surfactant

Examples of the surfactant are silicone-based surfactants, fluorochemical surfactants, amphoteric surfactants, nonionic surfactants, anionic surfactants, etc.

The silicone-based surfactant has no specific limit and can be suitably selected to suit to a particular application.

Of these, preferred are silicone-based surfactants which are not decomposed even in a high pH environment.

Specific examples include, but are not limited to, side-chain-modified polydimethylsiloxane, both-distal-end-modified polydimethyl siloxane, one-distal-end-modified polydimethylsiloxane, and side-chain-both-distal-end-modified polydimethylsiloxane. A silicone-based surfactant having a polyoxyethylene group or a polyoxypropylene group as a modification group is particularly preferable because such an agent demonstrates good properties as an aqueous surfactant. It is possible to use a polyether-modified silicone-based surfactant as the silicone-based surfactant. A specific example is a compound in which a polyalkylene oxide structure is introduced into the side chain of the Si site of dimethyl siloxane.

Specific examples of the fluorochemical surfactants include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactants do not easily produce foams.

Specific examples of the perfluoroalkyl sulfonic acid compounds include, but are not limited to, perfluoroalkyl sulfonic acid and salts of perfluoroalkyl sulfonic acid.

Specific examples of the perfluoroalkyl carboxylic acid compounds include, but are not limited to, perfluoroalkyl carboxylic acid and salts of perfluoroalkyl carboxylic acid.

Specific examples of the polyoxyalkylene ether polymer compounds having a perfluoroalkyl ether group in its side chain include, but are not limited to, salts of sulfuric acid ester of polyoxyalkylene ether polymer having a perfluoroalkyl ether group in its side chain and salts of polyoxyalkylene ether polymers having a perfluoroalkyl ether group in its side chain. Counter ions of salts in these fluorochemical surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactant has no particular limit and can be suitably selected to suit to a particular application.

Specific examples include, but are not limited to, side-chain-modified polydimethyl siloxane, both distal-end-modified polydimethylsiloxane, one-distal-end-modified polydimethylsil oxane, and side-chain-both-distal-end-modified polydimethylsiloxane. In particular, a polyether-modified silicone-based surfactant having a polyoxyethylene group or a polyoxyethylene polyoxypropylene group is particularly preferable because such a surfactant demonstrates good property as an aqueous surfactant.

Any suitably synthesized surfactant and any product available on the market is suitable. Products available on the market can be obtained from BYK-Chemie GmbH, Shin-Etsu Chemical Co., Ltd., Dow Corning Toray Co., Ltd., NIHON EMULSION Co., Ltd., Kyoeisha Chemical Co., Ltd., etc.

The polyether-modified silicon-based surfactant has no particular limit and can be suitably selected to suit to a particular application. For example, a compound is usable in which the polyalkylene oxide structure represented by the following Chemical formula S-1 is introduced into the side chain of the Si site of dimethyl polysiloxane.

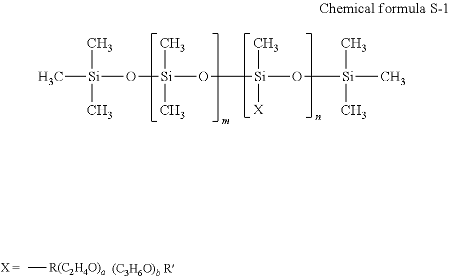

In Chemical formula S-1, “m”, “n”, “a”, and “b” each, respectively independently represent integers, R represents an alkylene group, and R′ represents an alkyl group.

Specific examples of polyether-modified silicone-based surfactants include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Co., Ltd.), BYK-33 and BYK-387 (both manufactured by BYK Japan KK.), and TSF4440, TSF4452, and TSF4453 (all manufactured by Momentive Performance Materials Inc.).

A fluorochemical surfactant in which the number of carbon atoms replaced with fluorine atoms is 2 to 16 is preferable and, 4 to 16, more preferable.

Specific examples of the fluorochemical surfactants include, but are not limited to, perfluoroalkyl phosphoric acid ester compounds, adducts of perfluoroalkyl ethylene oxide, and polyoxyalkylene ether polymer compounds having a perfluoroalkyl ether group in its side chain. Of these, polyoxyalkylene ether polymer compounds having a perfluoroalkyl ether group in the side chain thereof are preferable because these polymer compounds not easily foam and the fluorosurfactant represented by the following Chemical formula F-1 or Chemical formula F-2 is more preferable.

CF₃CF₂(CF₂CF₂)ₘ—CH₂CH₂O(CH₂CH₂O)ₙH Chemical formula F-1

In the compound represented by Chemical formula F-1, m is preferably 0 or an integer of from 1 to 10 and n is preferably 0 or an integer of from 1 to 40.

CₙF₂ₙ₊₁—CH₂CH(OH)CH₂—O—(CH₂CH₂O)ₐ—Y Chemical formula F-2

In the compound represented by the chemical formula F2, Y represents H or CₘF₂ₘ₊₁, where m represents an integer of from 1 to 6, or CH₂CH(OH)CH₂—CₘF₂ₘ₊₁, where m represents an integer of from 4 to 6, or CₚH₂ₚ₊₁, where p is an integer of from 1 to 19. “n” represents an integer of from 1 to 6. “a” represents an integer of from 4 to 14.

As the fluorochemical surfactant, products available on the market may be used.

Specific examples include, but are not limited to, SURFLON S-111, S-112, S-113, S-121, S-131, S-132, S-141, and S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFACE F-470, F-1405, and F-474 (all manufactured by DIC CORPORATION); ZONYL TBS, FSP, FSA, FSN-100, FSN, FSO-100, FSO, FS-300, UR, and Capstone™ FS-30, FS-31, FS-3100, FS-34, and FS-35 (all manufactured by The Chemours Company); FT-110, FT-250, FT-251, FT-400S, FT-150, and FT-400SW (all manufactured by NEOS COMPANY LIMITED); POLYFOX PF-136A, PF-156A, PF-151N, PF-154, and PF-159 (manufactured by OMNOVA SOLUTIONS INC.); and UNIDYNE™ DSN-403N (manufactured by DAIKIN INDUSTRIES, Ltd.). Of these, in terms of improvement on print quality, in particular coloring property and permeability, wettability, and uniform dying property on paper, FS-3100, FS-34, and FS-300 of The Chemours Company, FT-110, FT-250, FT-251, FT-400S, FT-150, and FT-400SW of NEOS COMPANY LIMITED, POLYFOX PF-151N of OMNOVA SOLUTIONS INC., and UNIDYNE™ DSN-403N (manufactured by DAIKIN INDUSTRIES, Ltd.) are particularly preferable.

The proportion of the surfactant in the ink is not particularly limited and can be suitably selected to suit to a particular application. For example, it is preferably from 0.001 to 5 percent by mass and more preferably from 0.05 to 5 percent by mass in terms of excellent wettability and discharging stability and improvement on image quality.

Defoaming Agent

The defoaming agent has no particular limit. For example, silicon-based defoaming agents, polyether-based defoaming agents, and aliphatic acid ester-based defoaming agents are suitable. These can be used alone or in combination. Of these, silicone-based defoaming agents are preferable in terms of the effect of foam breaking.

Preservatives and Fungicides

The preservatives and fungicides are not particularly limited. A specific example is 1,2-benzisothiazoline-3-one.

Corrosion Inhibitor

The corrosion inhibitor has no particular limitation. Specific examples include, but are not limited to, acid sulfites and sodium thiosulfates.

pH Regulator

The pH regulator has no particular limit as long as it can control pH to not lower than 7. Specific examples include, but are not limited to, amines such as diethanol amine and triethanol amine.

Properties of the ink are not particularly limited and can be suitably selected to suit to a particular application. For example, viscosity, surface tension, and pH are preferably in the following ranges.

Viscosity of the ink at 25 degrees C. is preferably from 5 to 30 mPa·s and more preferably from 5 to 25 mPas to improve print density and text quality and obtain good dischargeability. Viscosity can be measured by, for example, a rotatory viscometer (RE-80L, manufactured by TOKI SANGYO CO., LTD.). The measuring conditions are as follows:
Standard cone rotor (1° 34′ x R24)
Sample liquid amount: 1.2 mL
Rotational frequency: 50 rotations per minute (rpm)
25 degrees C.
Measuring time: three minutes

The surface tension of the ink is preferably 35 mN/m or less and more preferably 32 mN/m or less at 25 degrees C. in terms that the ink is suitably leveled on a recording medium and the drying time of the ink is shortened.

pH of the ink is preferably from 7 to 12 and more preferably from 8 to 11 in terms of prevention of corrosion of metal material in contact with liquid.

Pre-Processing Fluid

The pre-processing fluid includes a flocculant, an organic solvent, water, and optional materials such as a surfactant, a defoaming agent, a pH regulator, a preservatives and fungicides, and a corrosion inhibitor.

The organic solvent, the surfactant, the defoaming agent, the pH regulator, the preservatives and fungicides, and the corrosion inhibitor can be the same material as those for use in the ink. Also, other material for use in known processing fluid can be used.

The type of the flocculant is not particularly limited. For example, cationic polymers, aliphatic organic acid salt compounds, and inorganic metal compounds are preferable.

Examples of the cationic polymer include, but are not limited to, epichlorohydrin-dimethylamine addition polymers, dicyansiamide-formaline polycondensates, dicyandiamide diethylene triamine polycondensates, dimethyldiallyl ammoniumchloride SO₂ copolymers, diallylamine salt-SO₂ copolymers, dimethyldiallyl ammonium chloride polymers, polymers of allylamine salts, dialkylaminoethyl(meth)acrylate quaternary salt polymers, polyallylamine, cationic epoxy, polyethylene imines, polyacrylamides, poly(meth)acrylic acid esters, vinylformamide, cationic resin emulsions, and cationic resin multi-valent metal salts.

These cationic polymers are available on the market.

Specific examples include, but are not limited to, CATION G-50, SANSTAT E-818, SANFIX 70, SANFIX 555C, SANFIX LC-55, SANFIX PAC-700 conq, SANYO ELION A-3, SANFIX 414, SANFIX 555, SANFIX PRO-100, SANFIX 555US, and CELLOPOL YM-500 (all of which are manufactured by Sanyo Chemical Industries, Ltd.), #675, #FR-2P, and #1001 (all of which are manufactured by Sumitomo Chemical Company), and LUPASO SC 61B (manufactured by BASF). Also, other specific examples include, but are not limited to, ZP-700 (Vinylformamide-based), MP-184 (polyacrylic acid ester-based), MP-173H (polymethacrylic acid ester-based), MP-180 (polymethacrylic acid ester-based), MX-0210 (polymethacrylic acid ester-based), MX-8130 (polyacrylic acid ester-based), E-395 (polyacrylic acid ester-based), E-305 (polyacrylic acid ester-based), Q-101 (polyamine-based), Q-311 (polyamine-based), Q-501 (polyamine-based), Q-105H (dicyan amide-based), and Neo-600 (polyacrylamide-based), (all of which are manufactured by HYMO Co., Ltd.), Superfloc 2490 (polyacrylic acid salt-based), and Superfloc 3180, 3380, 3580, 3880, 3390, 3590, 3500, and SD2081 (polyacrylicamdie), Accofloc C498T and C498Y (polyacrylic acid ester-based), Superfloc 1500, 1600, Accofloc C481, C483, C485, C488, and C480 (polymethacrylic acid ester), Accofloc C567, C573, C577, and C581 (polyamine-based) (all of which are manufactured by Mitsui Scitech Co.).

The proportion of the cationic polymer in the pre-processing fluid is preferably from to 80 percent by mass and more preferably from 30 to 60 percent by mass. When the proportion is 10 percent by mass or greater, pigment agglomeration becomes sufficient. When the proportion is 80 percent by mass or less, image unevenness ascribable to aggregation of polymers does not occur.

Specific examples of the aliphatic organic acid salt compound include, but are not limited to, L-sodium aspartate, L-magnesium aspartate, calcium ascorbate, L-sodium ascorbate, sodium succinate, disodium succinate, diammonium succinate, aluminum citrate, potassium citrate, calcium citrate, triammonium citrate, tripotassium citrate, trisodium citrate, diammonium citrate, disodium citrate, zinc lactate, aluminum lactate, ammonium lactate, potassium lactate, calcium lactate, sodium lactate, magnesium lactate, potassium tartrate, calcium tartrate, DL-sodium tartrate, and sodium potassium tartrate.

The proportion of the aliphatic organic acid salt compound in the pre-processing fluid is preferably from 0.1 to 30 percent by mass and more preferably from 5 to 15 percent by mass. When the proportion is 0.1 percent by mass or greater, agglomeration becomes sufficiently effective. When the proportion is 30 percent by mass or less, the aliphatic organic acid salt compound can be prevented from precipitating.

Specific examples of the inorganic metal compound include, but are not limited to, magnesium sulfate, aluminum sulfate, manganese sulfate, nickel sulfate, iron (II) sulfate, copper (II) sulfate, zinc sulfate, iron (II) nitrate, iron (III) nitrate, cobalt nitrate, strontium nitrate, copper (II) nitrate, nickel (II) nitrate, lead (II) nitrate, manganese (II) nitrate, nickel (II) chloride, calcium chloride, tin (II) chloride, strontium chloride, barium chloride, magnesium chloride, sodium sulfate, potassium sulfate, lithium sulfate, sodium hydrogensulfate, potassium hydrogensulfate, sodium nitrate, potassium nitrate, sodium carbonate, potassium carbonate, sodium hydrogencarbonate, potassium hydrogencarbonate, sodium chloride, and potassium chloride, Of these, using a multi-valent metal salt is preferable to enhance agglomeration property of a coloring material and increase image density.

The proportion of the inorganic metal compound in the pre-processing fluid is preferably from 0.1 to 30 percent by mass and more preferably from 5 to 15 percent by mass. When the proportion is 0.1 percent by mass or greater, agglomeration becomes sufficient. When the proportion is 30 percent by mass or less, the inorganic metal compound can be prevented from precipitating.

The amount of applying the pre-processing fluid to a recording medium is for example, from 60 to 120 mg/A4.

According to the present disclosure, an ink set is provided which comprises a pre-processing fluid and a magenta ink comprising water, an azo pigment, a quinacridone pigment, and an organic solvent.

According to the set, the pigment in the set can stay on the surface of a recording medium, thereby obtaining a high image density. This set has a significant impact in particular on usage of pigments such as azo pigments having a small crystal diameter or finely-dispersed pigments since those pigments are not easily caught in fiber or a coating agent present on the surface of a recording medium and permeate the area deep inside the recording medium. As described above, it is more preferable that the pre-processing fluid comprise a cationic polymer, an aliphatic organic acid salt compound, and an inorganic metal compound because it accelerates pigment aggregation.

Also, as described above, of the azo pigments, pigments selected from at least one of C.I.PR150, C.I.PR269, and C.I.PR48:3 are preferable in terms of the dispersibility and mutual action with the quinacridone pigment. C.I.PR150 is more preferable. Moreover, to obtain high image density, of the quinacridone pigments, pigments selected from at least one of C.I.PR122, C.I.PR202, and C.I.PV19 are preferable. C.I.PR122 and/or C.I.PV19 is more preferable.

Post-Processing Fluid

The post-processing fluid has no particular limit. It is preferable that the post-processing fluid can form a transparent layer. Material such as organic solvents, water, resins, surfactants, defoaming agents, pH regulators, preservatives and fungicides, corrosion inhibitors, etc. is suitably selected based on a necessity basis and mixed to obtain the post-processing fluid. The post-processing fluid can be applied to the entire recording area formed on a recording medium or only the area on which an ink image is formed.

Recording Medium

Specific examples of the recording medium include, but are not limited to, plain paper, gloss paper, special paper, cloth, film, transparent sheets, and printing paper for general purpose. The recording medium is not limited to articles typically used as a recording medium. It is suitable to use building materials such as wall paper, floor material, and tiles. In addition, the configuration of the paths through which the recording medium is conveyed can be adjusted to use ceramics, glass, metal, etc. Notably, cloth and textile for apparel for T-shirts, etc. are not preferable as the recording medium because ink permeates deep inside those materials.

Recorded Matter

The ink printed matter of the present disclosure includes a recording medium and an image formed on the recording medium with the ink in the set of the present disclosure.

The recorded matter is obtained by an inkjet recording device executing an inkjet recording method.

Recording Device and Recording Method

The ink in the set of the present disclosure can be suitably applied to various recording devices employing an inkjet recording method, such as printers, facsimile machines, photocopiers, multifunction peripherals (serving as a printer, a facsimile machine, and a photocopier), and solid freeform fabrication devices (3D printers, additive manufacturing devices).

In the present disclosure, the recording device and the recording method respectively represent a device capable of discharging ink, various processing liquids, etc. to a recording medium and a method of recording utilizing the device. The recording medium means an article to which ink or various processing fluids can be temporarily or permanently attached.

The recording device may further optionally include a device relating to feeding, conveying, and ejecting a recording medium and other devices referred to as a pre-processing device, a post-processing device, etc. in addition to the head portion to discharge the ink.

The recording device and the recording method may further optionally include a heating device (heater) for use in the heating process and a drying device (drier) for use in the drying process. For example, the heating device and the drying device heat and dry the print surface and the opposite surface of a recording medium. The heating device and the drying device are not particularly limited. For example, a fan heater and an infra-red heater can be used. Heating and drying can be conducted before, in the middle of, or after printing.

In addition, the recording device and the recording method are not limited to those producing meaningful visible images such as texts and figures with ink. For example, the recording method and the recording device capable of producing patterns like geometric design and 3D images are included.

In addition, the recording device includes both a serial type device in which the discharging head is allowed to move and a line type device in which the liquid discharging head is not moved, unless otherwise specified.

Furthermore, in addition to the desktop type, this recording device includes a device capable of printing images on a wide recording medium such as AO and a continuous printer capable of using continuous paper rolled up in a roll-like form as a recording medium.

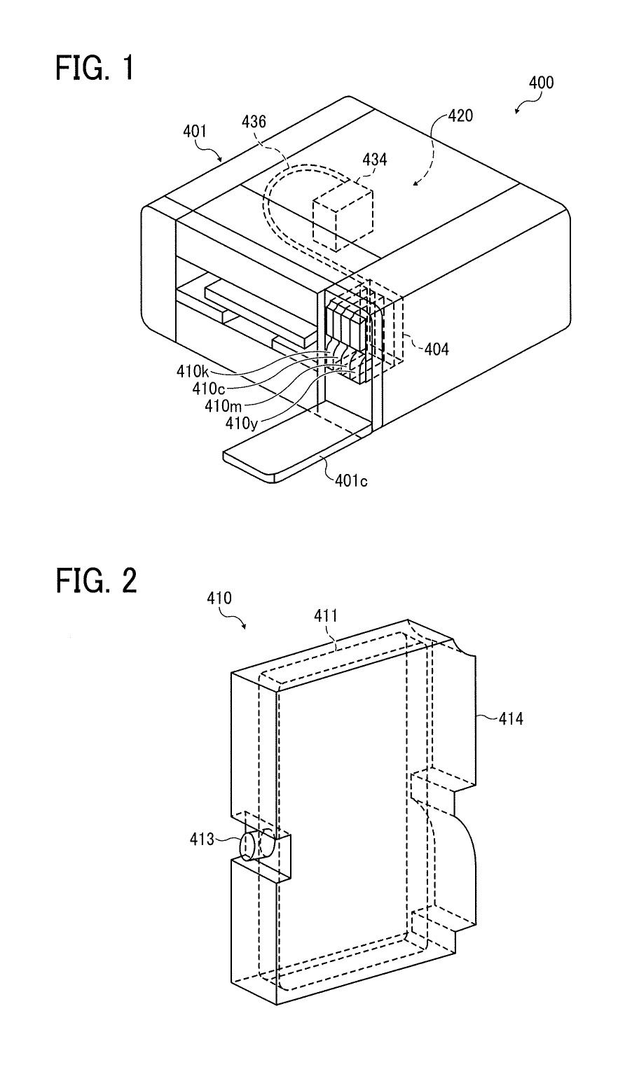

The recording device is described using an example with reference to FIG. 1 and FIG. 2. FIG. 1 is a diagram illustrating a perspective view of the recording device. FIG. 2 is a diagram illustrating a perspective view of the main tank. An image forming device 400 as an embodiment of the recording device is a serial type image forming device. A mechanical assembly 420 is disposed in an exterior 401 of the image forming device 400. Each ink accommodating unit 411 of each main tank 410 (410k, 410c, 410m, and 410y) for each color of black (K), cyan (C), magenta (M), and yellow (Y) is made of, for example, a packaging member such as aluminum laminate film. The ink accommodating unit 411 is housed in, for example, a plastic container housing unit 414. As a result, the main tank 410 is used as an ink cartridge of each color.

A cartridge holder 404 is disposed on the rear side of the opening appearing when a cover 401c is opened. The main tank 410 is detachably attached to the cartridge holder 404. This enables each ink outlet 413 of the main tank 410 to communicate with a discharging head 434 for each color via a supplying tube 436 for each color so as to discharge the ink from a discharging head 434 to a recording medium.

This recording device may include not only a portion to discharge ink but also devices referred to as a pre-processing device, a post-processing device, etc.

As an example of the pre-processing device and the post-processing device, as in the case of the ink such as black (K), cyan (C), magenta (M), and yellow (Y), the pre-processing device and the post-processing device may further include a liquid accommodating unit including a pre-processing fluid or a post-processing fluid and a liquid discharging head to discharge the pre-processing fluid or the post-processing fluid according to an inkjet printing method.

As another example of the pre-processing device and the post-processing device, it is suitable to dispose a pre-processing device and a post-processing device which do not employ the inkjet printing method but a blade coating method, a roll coating method, or a spray coating method.

Notably, the ink is applicable not only to the inkjet print method but can be widely applied to other methods.

Specific examples of such methods other than the inkjet recording method include, but are not limited to, blade coating methods, gravure coating methods, bar coating methods, roll coating methods, dip coating methods, curtain coating methods, slide coating methods, die coating methods, and spray coating methods.

### FIELD OF APPLICATION

The usage of the ink of the present disclosure is not particularly limited and can be suitably selected to suit to a particular application. For example, the ink can be used for printed matter, a paint, a coating material, and foundation. In addition, the solid fabrication object includes a molded processed product manufactured by processing a structure having a substrate such as a recording medium to which the ink is applied. The molded processed product is manufactured from recorded matter or a structure having a sheet-like form, film-like form, etc. by, for example, heating drawing or punching. The molded processed product is suitably used for articles which are molded after surface-decorating. Examples are gauges or operation panels of vehicles, office machines, electric and electronic devices, cameras, etc.

Image forming, recording, printing, print, etc. in the present disclosure represent the same meaning.

Also, recording media, media, substrates in the present disclosure have the same meaning.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Examples and Comparative Examples are described below. The present disclosure is not limited thereto. The amount (percent) of each component specified in Examples and Comparative Examples are solid content in percent by mass unless otherwise specified.

Preparation of Magenta Ink 1 to 8

After mixing and stirring each component of the formulation (percent by mass) shown in Table 1, 10 percent aqueous solution of lithium hydroxide was added to make pH to be 9, followed by filtration using a membrane filter having an average pore diameter of 0.1 m to obtain a magenta ink.

TABLE 1

| | | Magenta ink | | | | | | | |
|---|---|---|---|---|---|---|---|---|---|
| | | 1 | 2 | 3 | 4 | 5 | 6 | 7 | 8 |
| Azo pigment | PR57:1 | 1 | — | 1 | — | — | — | — | — |
| | PR48:3 | — | 1 | — | — | 1 | — | — | — |
| | PR150 | — | — | — | 1 | — | 1 | 2 | — |
| Quinacridone | PR209 | 1 | 1 | — | — | — | — | — | — |
| pigment | PR202 | — | — | 1 | 1 | — | — | — | — |
| | PR122 | — | — | — | — | 0.7 | 0.7 | — | 1.4 |
| | PV19 | — | — | — | — | 0.3 | 0.3 | — | 0.6 |

| | | | | | | | | |
|---|---|---|---|---|---|---|---|---|
| Glycerin | 5 | 5 | 5 | 5 | 5 | 5 | 5 | 5 |
| Diethylene glycol | 15 | 15 | 15 | 15 | 15 | 15 | 15 | 15 |
| Polyoxyethylene (3) | 1 | 1 | 1 | 1 | 1 | 1 | 1 | 1 |
| tridecyl ether sodium | | | | | | | | |
| acetate (anionic resin) | | | | | | | | |
| 2-ethyl-1,3-hexane diol | 1 | 1 | 1 | 1 | 1 | 1 | 1 | 1 |
| San-ai bac AP, fungicide, | 0.4 | 0.4 | 0.4 | 0.4 | 0.4 | 0.4 | 0.4 | 0.4 |
| manufactured by SAN-AI | | | | | | | | |
| OIL CO., LTD. | | | | | | | | |
| Deionized water | *Ba | *Ba | *Ba | *Ba | *Ba | *Ba | *Ba | *Ba |

*Ba represents balance.

Preparation of Magenta Inks 9 to 16

After mixing and stirring each component of the formulation (percent by mass) shown in Table 2, the mixture was filtrated using a membrane filter having an average pore diameter of 0.1 μm to obtain a magenta ink.

Preparation of Polymer Solution

After through replacement with nitrogen gas in a 1 L flask equipped with a mechanical stirrer, a thermometer, a nitrogen gas introducing tube, a reflux tube, and a dripping funnel, 11.2 g of styrene, 2.8 g of acrylic acid, 12.0 g of lauryl methacrylate, 4.0 g of polyethylene glycol methacrylate, 4.0 g of styrene macromer, and 0.4 g of mercapto ethanol were admixed in the flask and heated to 65 degrees C.

Next, a liquid mixture of 100.8 g of styrene, 25.2 g of acrylic acid, 108.0 g of lauryl methacrylate, 36.0 g of polyethylene glycol methacrylate, 60.0 g of hydroxyethyl methacrylate, 36.0 g of styrene macromer, 3.6 g of mercapto ethanol, 2.4 g of azobisdimethyl valeronitrile, and 18.0 g of methylethyl ketone was dripped into the flask in two and a half hours. Subsequently, a liquid mixture of 0.8 g of azobismethyl valeronitrile and 18.0 g of methylethyl ketone was dripped into the flask in half an hour. After one-hour aging at 65 degrees C., 0.8 g of azobismethyl valeronitrile was added and aged for another hour. After the reaction was complete, 364.0 g of methylethyl ketone was added to the flask to obtain 800 g of a polymer solution having a concentration of 50 percent by mass.

Preparation of Magenta Pigment Dispersion

Next, 28 g of the polymer solution, 42 g of C.I.PR 57:1, 13.6 g of 1 mol/L potassium hydroxide aqueous solution, 20.0 g of methyl ethyl ketone, and 13.6 g of deionized water were thoroughly stirred followed by mix-kneading using a roll mill to obtain a paste.

The thus-obtained paste was placed in 200 g of pure water followed by sufficient stirring. Methylethyl ketone and water were distilled away using an evaporator. Furthermore, to remove coarse particles, the resultant was filtrated under pressure by a polyvinylidene fluoride membrane filter having an average pore diameter of 5.0 μm. Consequently, a liquid dispersion of magenta pigment of C.I.PR57:1 was obtained, which contained a pigment in an amount of 15 percent by mass and a solid content of 20 percent by mass.

C.I.PR48:3, PR150, PR209, PR202, PR122, and PV19 were subjected to the same operation to obtain respective dispersions.

TABLE 2

| | | Magenta ink | | | | | | | |
|---|---|---|---|---|---|---|---|---|---|
| | | 9 | 10 | 11 | 12 | 13 | 14 | 15 | 16 |
| Azo pigment | PR57:1 | 30 | — | 30 | — | — | — | — | — |
| dispersion | PR48:3 | — | 30 | — | — | 30 | — | — | — |
| | PR150 | — | — | — | 30 | — | 30 | 60 | — |
| Quinacridone | PR209 | 30 | 30 | — | — | — | — | — | — |
| pigment dispersion | PR202 | — | — | 30 | 30 | — | — | — | — |
| | PR122 | — | — | — | — | 21 | 21 | — | 42 |
| | PV19 | — | — | — | — | 9 | 9 | — | 18 |

| | | | | | | | | |
|---|---|---|---|---|---|---|---|---|
| Fluorochemical resin emulsion | 5.8 | 5.8 | 5.8 | 5.8 | 5.8 | 5.8 | 5.8 | 5.8 |
| (LUMIFLON ® FE4500, solid | | | | | | | | |
| content of 52 percent by mass, | | | | | | | | |
| manufactured by ASAHI | | | | | | | | |
| GLASS CO., LTD.) | | | | | | | | |
| 1,3-butane diol | 15 | 15 | 15 | 15 | 15 | 15 | 15 | 15 |
| Glycerin | 10 | 10 | 10 | 10 | 10 | 10 | 10 | 10 |
| 2-ethyl-1,3-hexane diol | 2 | 2 | 2 | 2 | 2 | 2 | 2 | 2 |
| KF-640 (surfactant) | 1 | 1 | 1 | 1 | 1 | 1 | 1 | 1 |
| Proxel GXL (mildew-proofing | 0.05 | 0.05 | 0.05 | 0.05 | 0.05 | 0.05 | 0.05 | 0.05 |
| agent) | | | | | | | | |
| Silicone defoaming agent KM- | 0.1 | 0.1 | 0.1 | 0.1 | 0.1 | 0.1 | 0.1 | 0.1 |
| 72F | | | | | | | | |
| 2-Amino-2-ethyl-1,3- | 0.3 | 0.3 | 0.3 | 0.3 | 0.3 | 0.3 | 0.3 | 0.3 |
| propanediol (pH regulator) | | | | | | | | |
| Deionized water | *Ba | *Ba | *Ba | *Ba | *Ba | *Ba | *Ba | *Ba |

Preparation of Magenta Inks 17 to 24

After mixing and stirring each component of the formulation (percent by mass) shown in Table 3, the mixture was filtrated using a membrane filter having an average pore diameter of 0.1 m to obtain a magenta ink. Respective pigment dispersions were obtained in the same manner as for Magenta inks 9 to 16.

TABLE 3

| | | Magenta ink | | | | | | | |
|---|---|---|---|---|---|---|---|---|---|
| | | 17 | 18 | 19 | 20 | 21 | 22 | 23 | 24 |
| Azo pigment | PR57:1 | 27 | — | 27 | — | — | — | — | — |
| dispersion | PR48:3 | — | 27 | — | — | 27 | — | — | — |
| | PR150 | — | — | — | 27 | — | 27 | 54 | — |
| Quinacridone | PR209 | 27 | 27 | — | — | — | — | — | — |
| pigment | PR202 | — | — | 27 | 27 | — | — | — | — |
| dispersion | PR122 | — | — | — | — | 19 | 19 | — | 38 |
| | PV19 | — | — | — | — | 8 | 8 | — | 16 |

| | | | | | | | | |
|---|---|---|---|---|---|---|---|---|
| 1,3-butane diol | 21.8 | 21.8 | 21.8 | 21.8 | 21.8 | 21.8 | 21.8 | 21.8 |
| Glycerin | 14.5 | 14.5 | 14.5 | 14.5 | 14.5 | 14.5 | 14.5 | 14.5 |
| 2-ethyl-1,3-hexane diol | 1 | 1 | 1 | 1 | 1 | 1 | 1 | 1 |
| 2,2,4-trimethyl1,3- | 1 | 1 | 1 | 1 | 1 | 1 | 1 | 1 |
| pentanediol | | | | | | | | |
| Zonyl ™ FS-300 | 2.5 | 2.5 | 2.5 | 2.5 | 2.5 | 2.5 | 2.5 | 2.5 |
| (surfactant) | | | | | | | | |
| Proxel GXL (mildew- | 0.05 | 0.05 | 0.05 | 0.05 | 0.05 | 0.05 | 0.05 | 0.05 |
| proofing agent) | | | | | | | | |
| Silicone defoaming agent | 0.1 | 0.1 | 0.1 | 0.1 | 0.1 | 0.1 | 0.1 | 0.1 |
| KM-72F | | | | | | | | |
| 2-Amino-2-ethyl-1,3- | 0.2 | 0.2 | 0.2 | 0.2 | 0.2 | 0.2 | 0.2 | 0.2 |
| propanediol (pH | | | | | | | | |
| regulator) | | | | | | | | |
| Deionized water | *Ba | *Ba | *Ba | *Ba | *Ba | *Ba | *Ba | *Ba |

Preparation of Pre-Processing Fluid 1 (Containing Cationic Polymer)

After mixing and stirring each component of the following formulation, triethanol was added to make pH to be 7, thereby obtaining Pre-processing fluid 1.

| | | |
|---|---|---|
| Cation G-50 (alkyldimethyl benzyl ammonium | 1 | percent by mass |
| chloride, cationic surfactant, manufactured by | | |
| Sanyo Chemical Industries, Ltd.): | | |
| PAS-J-81L (copolymer of diallyl dimethyl- | 50 | percent by mass |
| ammonoum chloride acrylamide, manufactured by | | |
| NITTOBO MEDICAL CO., LTD.) (average | | |
| polymerization molecular weight of 10,000): | | |
| Glycerin: | 10 | percent by mass |
| SAN-ai bac AP (fungicide, manufactured by | 0.4 | percent by mass |
| SAN-AI OIL CO., LTD.): | | |

| | |
|---|---|
| Triethanol amine: | added to adjust |
| | pH to be 7 |
| Deionized water: | Balance |

Preparation of Pre-Processing Fluid 2 (Containing Aliphatic Organic Acid Salt Compound)

After mixing and stirring each component of the following formulation, the resultant was filtrated under pressure using a polyvinilydene fluoride membrane filter having an average pore diameter of 5.0 m to remove coarse particles and dust to prepare Processing fluid 2.

| | |
|---|---|
| Calcium lactate: | 10 percent by mass |
| 1,3-butane diol: | 10 percent by mass |
| Glycerin: | 10 percent by mass |
| 2-ethyl-1,3-hexane diol: | 1 percent by mass |
| Deionized water: | Balance |

Preparation of Pre-Processing Fluid 3 (Containing Inorganic Metal Compound)

After mixing and stirring each component of the following formulation, the resultant was filtrated under pressure using a polyvinilydene fluoride membrane filter having an average pore diameter of 5.0 m to remove coarse particles and dust to prepare Processing fluid 3.

| | |
|---|---|
| Magnesium sulfate: | 10 percent by mass |
| 1,3-butane diol: | 10 percent by mass |
| Glycerin: | 10 percent by mass |
| 2-ethyl-1,3-hexane diol: | 1 percent by mass |
| Deionized water: | Balance |

### Examples 1 to 18 and Comparative Examples 1 to 15

The magenta ink and the pre-processing fluid were used in combination shown in Tables 4 to 6 to evaluate dispersibility, light resistance, and image density of the magenta ink. To evaluate dispersibility of the magenta ink, the pre-processing fluid was not used but only the ink was used. The results are shown in Tables 4 to 6.

Evaluation on Dispersibility of Magenta Ink

Viscosity of the magenta ink was measured at 25 degrees C. using a viscometer (RE-80L, RE-550L, manufactured by TOKI SANGYO CO., LTD.). Thereafter, the magenta ink was stored in a sealed container at 70 degrees C. for 14 days and viscosity thereof was measured in the same manner. The value of the dispersion stability was calculated according to the following relation and evaluated according to the following criteria.

Dispersion stability (percent)=(Viscosity after storage/Viscosity before storage)×100 Evaluation Criteria on Dispersibility

S: Dispersion stability from 95 to 105 percent
A: Dispersion stability from 90 to less than 95 percent and more than 105 to 110 percent
B: Dispersion stability from more than 80 to less than 90 percent and more than 110 to less than 120 percent
C: Dispersion stability of 80 percent or less or 120 percent or more

Evaluation on Light Resistance

An ink cartridge with which the ink and the pre-processing fluid was filled was mounted onto an inkjet printer (IPSiO G707, manufactured by Ricoh Co., Ltd.). After the pre-processing fluid was applied to coated paper LAG90 in a solid image manner with one pass, the magenta ink was applied thereto to form a solid image with one pass. Using a Weather-Ometer® Ci35AW (manufactured by AMETEK, Inc.), Xenon radiation illuminance of 0.35 W/m² (340 nm) approximated to outdoor sun light was applied to the solid image for 24 hours in an environment at 70 degrees C. and 50 percent RH with a black panel temperature of 89 degrees C. to evaluate light resistance based on fading and color change between before and after the application according to the following evaluation criteria.

Evaluation Criteria on Light Resistance

S: No change
A: Little change
B: Fading and color change occurred
C: Apparent fading and color change occurred to a degree that white background of substrate was able to be seen

Evaluation on Density

An image was formed in the same manner as in the evaluation on light resistance. The recording medium subjected to the testing was plain paper MyPaper (manufactured by Ricoh Co., Ltd.) in addition to the coated paper LAG90. The density of the solid image was measured by a reflection type color spectrophotometer densitometer (manufactured by X-Rite Inc.).

Evaluation Criteria of Density

S: OD of 1.1 or higher
A: OD of 1.0 to less than 1.1
B: OD of 0.9 to less than 1.0
C: Less than 0.9

TABLE 4

| | | Pre-processing | | Light | Density | |
|---|---|---|---|---|---|---|
| | Ink | fluid | Dispersibility | resistance | LAG90 | MyPaper |
| Example 1 | Magenta | Pre-processing | B | B | B | B |
| | ink 1 | fluid 1 (cationic | | | | |
| | | polymer) | | | | |
| Example 2 | Magenta | Pre-processing | B | A | A | A |
| | ink 2 | fluid 1 (cationic | | | | |
| | | polymer) | | | | |
| Example 3 | Magenta | Pre-processing | A | B | B | B |
| | ink 3 | fluid 1 (cationic | | | | |
| | | polymer) | | | | |
| Example 4 | Magenta | Pre-processing | A | A | A | A |
| | ink 4 | fluid 1 (cationic | | | | |
| | | polymer) | | | | |
| Example 5 | Magenta | Pre-processing | A | A | A | A |
| | ink 5 | fluid 1 (cationic | | | | |
| | | polymer) | | | | |
| Example 6 | Magenta | Pre-processing | S | S | S | A |
| | ink 6 | fluid 1 (cationic | | | | |
| | | polymer) | | | | |
| Comparative | Magenta | Pre-processing | S | C | B | B |
| Example 1 | ink 7 | fluid 1 (cationic | | | | |
| | | polymer) | | | | |
| Comparative | Magenta | Pre-processing | C | S | S | A |
| Example 2 | ink 8 | fluid 1 (cationic | | | | |
| | | polymer) | | | | |
| Comparative | Magenta | None | — | C | C | C |
| Example 3 | ink 7 | | | | | |
| Comparative | Magenta | None | — | S | A | C |
| Example 4 | ink 8 | | | | | |
| Comparative | Magenta | None | — | S | C | C |
| Example 5 | ink 6 | | | | | |

TABLE 5

| | | Pre-processing | | Light | Density | |
|---|---|---|---|---|---|---|
| | Ink | fluid | Dispersibility | resistance | LAG90 | MyPaper |
| Example 7 | Magenta | Pre-processing | B | B | B | B |
| | ink 9 | fluid 2 (aliphatic | | | | |
| | | organic acid salt | | | | |
| | | compound) | | | | |
| Example 8 | Magenta | Pre-processing | B | A | A | A |
| | ink 10 | fluid 2 (aliphatic | | | | |
| | | organic acid salt | | | | |
| | | compound) | | | | |
| Example 9 | Magenta | Pre-processing | A | B | B | B |
| | ink 11 | fluid 2 (aliphatic | | | | |
| | | organic acid salt | | | | |
| | | compound) | | | | |
| Example 10 | Magenta | Pre-processing | A | A | A | A |
| | ink 12 | fluid 2 (aliphatic | | | | |
| | | organic acid salt | | | | |
| | | compound) | | | | |
| Example 11 | Magenta | Pre-processing | A | A | A | A |
| | ink 13 | fluid 2 (aliphatic | | | | |
| | | organic acid salt | | | | |
| | | compound) | | | | |
| Example 12 | Magenta | Pre-processing | S | S | S | A |
| | ink 14 | fluid 2 (aliphatic | | | | |
| | | organic acid salt | | | | |
| | | compound) | | | | |
| Comparative | Magenta | Pre-processing | S | C | B | B |
| Example 6 | ink 15 | fluid 2 (aliphatic | | | | |
| | | organic acid salt | | | | |
| | | compound) | | | | |
| Comparative | Magenta | Pre-processing | C | S | S | A |
| Example 7 | ink 16 | fluid 2 (aliphatic | | | | |
| | | organic acid salt | | | | |
| | | compound) | | | | |
| Comparative | Magenta | None | — | C | C | C |
| Example 8 | ink 15 | | | | | |
| Comparative | Magenta | None | — | S | A | C |
| Example 9 | ink 16 | | | | | |
| Comparative | Magenta | None | — | S | C | C |
| Example 10 | ink 14 | | | | | |

TABLE 6

| | | Pre-processing | | Light | Density | |
|---|---|---|---|---|---|---|
| | Ink | fluid | Dispersibility | resistance | LAG90 | MyPaper |
| Example 13 | Magenta | Pre-processing | B | B | B | B |
| | ink 17 | fluid 3 | | | | |
| | | (inorganic | | | | |
| | | metal | | | | |
| | | compound) | | | | |
| Example 14 | Magenta | Pre-processing | B | A | A | A |
| | ink 18 | fluid 3 | | | | |
| | | (inorganic | | | | |
| | | metal | | | | |
| | | compound) | | | | |
| Example 15 | Magenta | Pre-processing | A | B | B | B |
| | ink 19 | fluid 3 | | | | |
| | | (inorganic | | | | |
| | | metal | | | | |
| | | compound) | | | | |
| Example 16 | Magenta | Pre-processing | A | A | A | A |
| | ink 20 | fluid 3 | | | | |
| | | (inorganic | | | | |
| | | metal | | | | |
| | | compound) | | | | |
| Example 17 | Magenta | Pre-processing | A | A | A | A |
| | ink 21 | fluid 3 | | | | |
| | | (inorganic | | | | |
| | | metal | | | | |
| | | compound) | | | | |
| Example 18 | Magenta | Pre-processing | S | S | S | A |
| | ink 22 | fluid 3 | | | | |
| | | (inorganic | | | | |
| | | metal | | | | |
| | | compound) | | | | |
| Comparative | Magenta | Pre-processing | S | C | B | B |
| Example 11 | ink 23 | fluid 3 | | | | |
| | | (inorganic | | | | |
| | | metal | | | | |
| | | compound) | | | | |
| Comparative | Magenta | Pre-processing | C | S | S | A |
| Example 12 | ink 24 | fluid 3 | | | | |
| | | (inorganic | | | | |
| | | metal | | | | |
| | | compound) | | | | |
| Comparative | Magenta | None | — | C | C | C |
| Example 13 | ink 23 | | | | | |
| Comparative | Magenta | None | — | S | A | C |
| Example 14 | ink 24 | | | | | |
| Comparative | Magenta | None | — | S | C | C |
| Example 15 | ink 22 | | | | | |

As seen in the results shown in Tables 4 to 6, since a method including applying a pre-processing fluid to a recording medium and thereafter applying an ink comprising water, an azo pigment, a quinacridone pigment, and an organic solvent to the recording medium to form an image is applied in each Example, each Example demonstrated striking a balance between pigment dispersibility, light resistance, and image density at a high level in comparison with Comparative Examples.

Having now fully described embodiments of the present invention, it will be apparent to one of ordinary skill in the art that many changes and modifications can be made thereto without departing from the spirit and scope of embodiments of the invention as set forth herein.

What is claimed is:

1. An image forming method comprising:
applying a pre-processing fluid to a recording medium; and
applying an ink to the recording medium to form an image thereon;
wherein the ink comprises a magenta ink comprising water, an azo pigment, a quinacridone pigment, and an organic solvent.

2. The image forming method according to claim 1, wherein the azo pigment comprises at least one member selected from the group consisting of C.I.PR150, C.I.PR269, and C.I.PR48:3.

3. The image forming method according to claim 1, wherein the quinacridone pigment comprises at least one member selected from the group consisting of C.I.PR122, C.I.PR202, and C.I.PV19.

4. The image forming method according to claim 1, wherein the azo pigment comprises C.I.PR150 and the quinacridone pigment comprises at least one of C.I.PR122 and C.I.PV19.

5. The image forming method according to claim 1, wherein the pre-processing fluid comprises a cationic polymer.

6. The image forming method according to claim 1, wherein the pre-processing fluid comprises an aliphatic organic acid salt compound.

7. The image forming method according to claim 1, wherein the pre-processing fluid comprises an inorganic metal compound.

8. A method of manufacturing printed matter, comprising:
applying a pre-processing fluid to a recording medium; and
applying an ink to the recording medium to form an image thereon;
wherein the ink comprises a magenta ink comprising water, an azo pigment, a quinacridone pigment, and an organic solvent.

9. A set of pre-processing fluid and ink, comprising:
a pre-processing fluid; and
a magenta ink comprising water, an azo pigment, a quinacridone pigment, and an organic solvent.

10. The set according to claim 9, wherein the pre-processing fluid comprises any one of a cationic polymer, an aliphatic organic acid salt compound, and an inorganic metal compound.

11. The set according to claim 9, wherein the azo pigment comprises at least one member selected from the group consisting of C.I.PR150, C.I.PR269, and C.I.PR48:3 and the quinacridone pigment comprises at least one member selected from the group consisting of C.I.PR122, C.I.PR202, and C.I.PV19.
